(19) United States
(12) Patent Application Publication
(10) Pub. No.: US 2016/0270023 A1
(43) Pub. Date: Sep. 15, 2016

(54) SEEKING DEVICE AND COMMUNICATION SYSTEM

(71) Applicants: Tetsuya ASHIZUKA, Dazaifu-shi, Fukuoka (JP); Koichi IIDA, Kasuya-gun, Fukuoka (JP); Manabu KATO, Handa-shi, Aichi (JP)

(72) Inventors: Tetsuya ASHIZUKA, Fukuoka (JP); Koichi IIDA, Fukuoka (JP)

(21) Appl. No.: 15/032,685

(22) PCT Filed: Nov. 26, 2014
(86) PCT No.: PCT/JP2014/005912

§ 371 Date: Apr. 28, 2016

(30) Foreign Application Priority Data
Nov. 27, 2013 (JP) 2013-245284
May 1, 2014 (JP) 2014-094510

(51) Int. Cl. H04W 64/00; G01S 5/02; H04W 52/02

(52) U.S. Cl. CPC H04W 64/003; H04W 52/0209; G01S 5/02; G01S 5/0231

(57) ABSTRACT

This invention provides communication devices that can increase the possibility of finding a person and further can shorten the time in which the person is found. A sought device (2) supplies a power to each of a plurality of components thereof during a first time period, thereby performing a reception process. A seeking device (1) repetitively transmits a call signal during a third time period that is longer than the first interval. When having received the call signal, the sought device (2) transmits a response signal which includes identification information of the sought device during a fourth time period. The seeking device (1) uses the response signal to estimate the distance and direction of the sought device (2), and causes the identification information of the sought device (2) and information related to the distance and direction of the sought device (2) to be displayed.

### TECHNICAL FIELD

The present invention relates to a search apparatus for searching another communication apparatus (search-target apparatus), and also to a communication system composed of a search apparatus and a search-target apparatus.

### BACKGROUND ART

Radio-wave beacon systems have been known, each configured to inform, when a mountain climber is lost due to an avalanche or the like, a rescuer carrying a reception apparatus, of the location where the mountain climber is lost, by transmission of a radio wave from a transmission apparatus (small transmitter) carried by the mountain climber (e.g., PTLs 1 and 2 and NPL 1).

In this radio-wave beacon system, the transmission apparatus transmits a radio wave of 457 kHz as a rescue signal, and the reception apparatus thus can find out the direction and an approximate distance to the transmission apparatus based on the received radio wave.

### CITATION LIST

### Patent Literature

PTL 1

Japanese Patent Application Laid-Open No. 2003-198389

PTL 2

Japanese Patent Application Laid-Open No. 2005-229449

NPL 1: Report of Conference on Improving Beacon Systems for Searching Lost Mountain Climbers (Conference on Improving Beacon Systems for Searching Lost Mountain Climbers by Ministry of International Affairs and Communications, Western Region (Hokuriku) General Communication Bureau, March 2005)

### SUMMARY OF INVENTION

### Technical Problem

However, the radio-wave beacon system described above uses a medium-wave band frequency (457 kHz), and the transmission output of the radio-wave beacon system is limited within a micro-power range due to the restrictions under the Radio Law, so that the radio-wave receivable distance of the radio wave beacon system is up to approximately 100 m, and the radio wave beacon system cannot conduct a search when the distance in between increases to greater than 100 m.

As disclosed in NPL 1, for this kind of communication systems, a communication system with a long communication distance is in demand for enabling a wide-range search (e.g., at least several hundred meters in radius).

Moreover, for this kind of communication systems, apparatuses to be carried by mountain climbers, provided with the following features are in demand: being small and light; being capable of securing surely transmitting a radio wave without any operation of a mountain climber when the mountain climber is lost; and being capable of continuously operating for a long period (e.g., seven days or longer) via power saving, for example.

In general, in rescuing a lost climber, for example, a plurality of searchers forms a rescue team to rescue a lost climber or the like. In rescue activities, it is important for each member of the rescue team to be aware of the actions of the other rescue members, such as an action that, for example, one of the searchers has found a lost climber.

Development of the communication system that satisfies these demands further increases the possibility of finding a lost mountain climber or the like and expectedly reduces the time until the lost mountain climber or the like is found.

An object of the present invention to provide, in consideration of the points mentioned above, a search apparatus and a communication system each capable of increasing the possibility of finding a lost mountain climber or the like and also capable of reducing the time until the lost mountain climber or the like is found, as compared with the related art.

Another object of the present invention is to provide a search apparatus capable of allowing, when a search-target apparatus of a lost climber or the like is searched for by a plurality of search apparatuses, another search apparatus to easily confirm that one of the plurality of search apparatuses has been able to start communication with the search-target apparatus.

### Solution to Problem

A search apparatus according to the present invention is portable and performs radio communication with a portable search-target apparatus, the search apparatus including: a transmission section that transmits a call signal to the search-target apparatus; a reception section that receives a response signal from the search-target apparatus; and a control section that acquires, from the response signal, when the search-target apparatus is in communication with another search apparatus, identification information of the other search apparatus in communication with the search-target apparatus, and that causes the acquired identification information to be output.

A search apparatus according to the present invention is portable and performs radio communication with a portable search-target apparatus, the search apparatus including: a transmission section that transmits a call signal to the search-target apparatus; a reception section that receives a response signal from the search-target apparatus or a response confirmation signal transmitted from another search apparatus in communication with the search-target apparatus, the response confirmation signal corresponding to the response signal; and a control section that acquires identification information of the search-target apparatus and identification information of the other search apparatus from the response signal or the response confirmation signal, and that causes the acquired identification information to be output.

### Advantageous Effects of Invention

According to the present invention, a search-target apparatus is no longer required to always transmit a periodical signal such as a beacon and is only required to transmit a response signal upon reception of a call signal from a search apparatus. Thus, the power consumption of the search-target apparatus is reduced as compared with the apparatus of the related art. For this reason, the search-target apparatus is capable of continuously operating for a long period (e.g., three months or more), thus making it possible to increase the possibility of finding a lost mountain climber, for example.

According to the present invention, search apparatuses are capable of conducting a wide range search (e.g., 100 m to 5 km), thus increasing the possibility of finding a lost mountain climber or the like and making it possible to reduce the time until the lost mountain climber or the like is found.

According to the present invention, in an attempt to search for one search-target apparatus, using a plurality of search apparatuses, in a case where one of the search apparatuses has been able to start communication with the search-target apparatus, another search apparatus is allowed to easily find out that the search-target apparatus has been found, and to easily confirm the search apparatus in communication with the search-target apparatus. For this reason, when a search is conducted by a team composed of a plurality of searchers, efficient and fast rescue activities can be performed for a lost climber or the like.

### BRIEF DESCRIPTION OF DRAWINGS

FIGS. 1A to 1D are each an external view of a search apparatus according to Embodiment 1 of the present invention;

FIG. 2 is an external view of a search-target apparatus according to Embodiment 1 of the present invention;

FIG. 3 is a block diagram illustrating a configuration of the search apparatus according to Embodiment 1 of the present invention;

FIG. 4 is a block diagram illustrating a configuration of the search-target apparatus according to Embodiment 1 of the present invention;

FIG. 5 is a sequence diagram illustrating how communication is performed between the search apparatus and search-target apparatus according to Embodiment 1 of the present invention;

FIG. 6 is another sequence diagram illustrating how communication is performed between the search apparatus and search-target apparatus according to Embodiment 1 of the present invention;

FIG. 7 is a diagram illustrating a relationship between a distance and received signal strength;

FIG. 8 is a diagram illustrating a directivity formed by the search apparatus according to Embodiment 1 of the present invention;

FIG. 9 is a diagram illustrating an information table stored in a memory section of the search apparatus according to Embodiment 1 of the present invention;

FIGS. 10A to 10F are each a diagram illustrating a display screen of the search apparatus according to Embodiment 1 of the present invention;

FIGS. 11A and 11B illustrate a flowchart indicating an operation flow of the search apparatus according to Embodiment 1 of the present invention;

FIG. 12 is a flowchart indicating an operation flow of the search-target apparatus according to Embodiment 1 of the present invention;

FIG. 13 is a diagram illustrating an example of a use state of a search apparatus according to Embodiment 2 of the present invention;

FIG. 14 is a sequence diagram illustrating how communication is performed between the search apparatus and a search-target apparatus according to Embodiment 2 of the present invention;

FIGS. 15A and 15B illustrate a flowchart indicating an operation flow of the search apparatus according to Embodiment 2 of the present invention; and

FIG. 16 is a diagram illustrating a display screen of the search apparatus according to Embodiment 2 of the present invention.

### DESCRIPTION OF EMBODIMENTS

### Embodiment 1

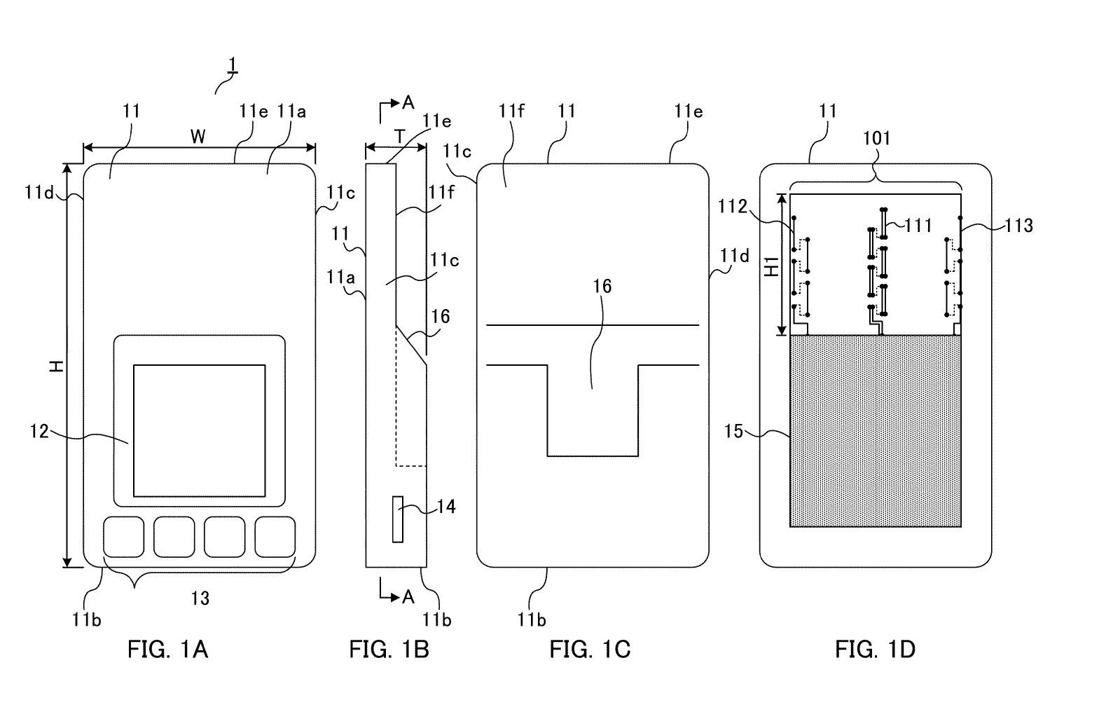

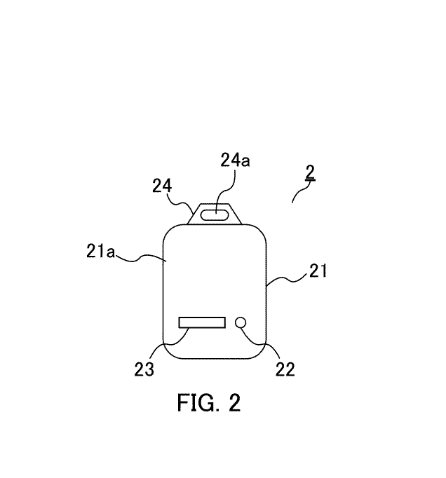

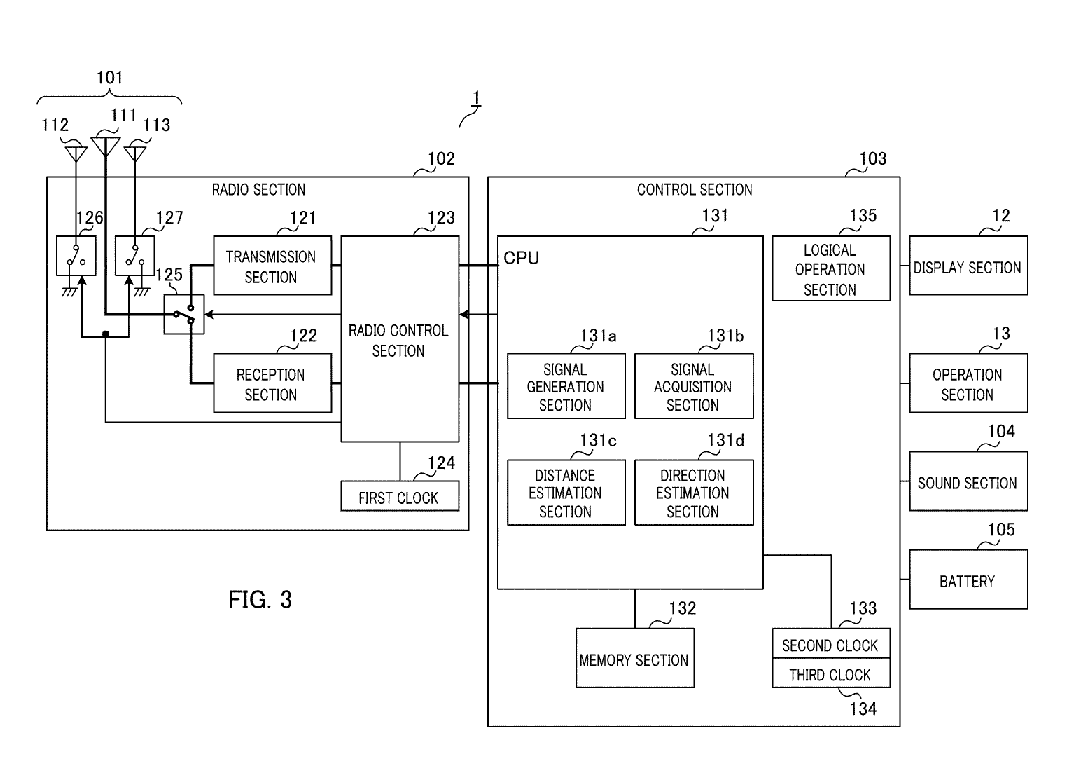

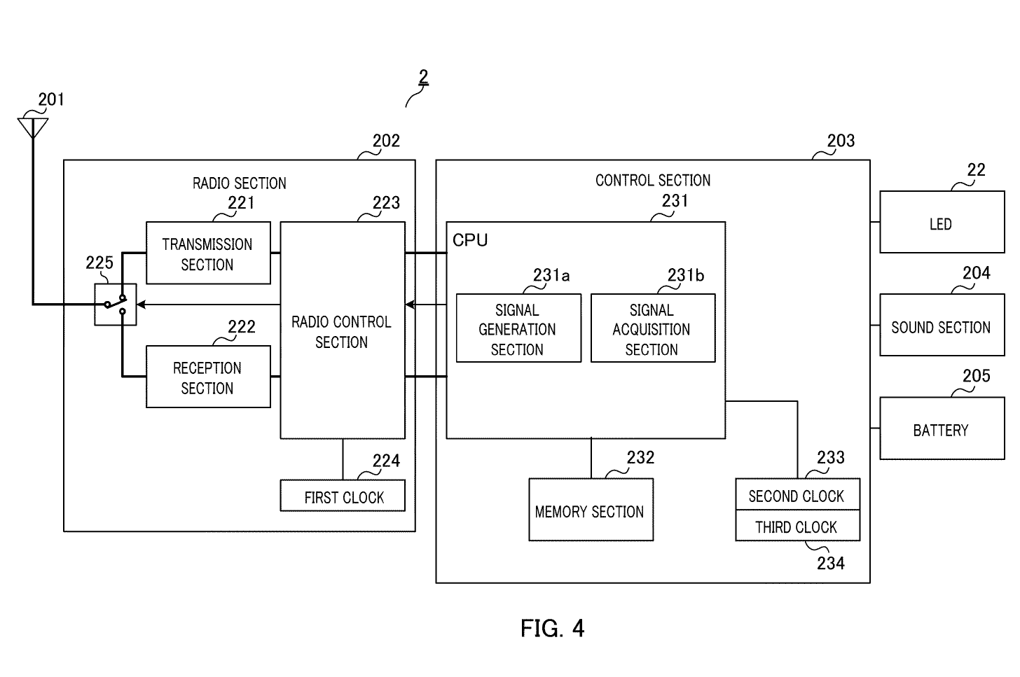

Hereinafter, a description will be given of Embodiment 1 of the present invention with reference to the accompanying drawings. A communication system according to Embodiment 1 is composed of search apparatus 1 (see FIGS. 1A to 1D, and FIG. 3) and one or more search-target apparatuses 2 (see FIGS. 2 and 4). Search apparatus 1 performs radio communication with each search-target apparatus 2. In addition, search apparatus 1 includes all the functions which are provided to search-target apparatus 2 and is capable of performing radio communication with another search apparatus, as a search-target apparatus.

### Communication Modes

Search apparatus 1 according to the present invention executes one of the following communication modes based on a user indication.

(1) Individual Search Mode

(2) All Search Mode

(3) Group Search Mode

(4) Search-Target Mode

(1) The individual search mode is a communication mode in which search apparatus 1 performs radio communication with single search-target apparatus 2 indicated by a user and estimates a relative position (distance and direction) of this single search-target apparatus 2. Note that, search apparatus 1 is capable of previously registering search-target apparatuses 2 in association with registration numbers (e.g., 1 to 10).

(2) The all search mode is a communication mode in which search apparatus 1 makes a request for transmission of a response signal to all search-target apparatuses 2 and then receives a response signal and identifies communicable search-target apparatus 2.

(3) The group search mode is a communication mode in which search apparatus 1 makes a request for transmission of a response signal to all the previously registered search-target apparatuses 2 and then receives a response signal and identifies communicable search-target apparatus 2.

(4) The search-target mode is a communication mode in which search apparatus 1 performs, as a search-target apparatus, radio communication with another search apparatus.

### Structure of Search Apparatus 1

First, a description will be given of a structure of search apparatus 1 using FIGS. 1A to 1D. FIGS. 1A to 1D are a front view, a right side view, a rear view, and an A-A cross-sectional view, respectively.

Search apparatus 1 is in size and weight that allow a user (standard individual) to carry around (for example, width W: 64 mm, height H: 107 mm, and thickness T: 13 mm and weight may be 70 g).

Case 11 of search apparatus 1 has a rectangular cube and is formed using a non-conductive member. Front surface 11a of case 11 has a flat panel shape. Front surface 11a of case 11 is provided with display section 12 and operation section 13.

Display section 12 is provided on front surface 11a of case 11 and includes a screen composed of a liquid crystal display (LCD), for example. Note that, a description of a display screen in each communication mode will be given hereinafter.

Operation section 13 is provided near the side of bottom surface 11b (lower end side) on front surface 11a of case 11 and includes a plurality of buttons. Operation section 13 converts the content of a button operation based on the user's intention into an electrical signal and transmits the electrical signal to central processing unit (CPU) 13 (see FIG. 3).

Side surfaces 11c and 11d of case 11 are thinner on the side of flat surface 11e (upper end side) than on the side of bottom surface 11b (lower end side) with respect to a center portion of case 11 as the boundary. Right side surface 11c is provided with power supply switch 14.

Case 11 houses substrate 15 therein. Antenna 101 is patterned on the side of flat surface 11e (upper end side) with respect to the center of substrate 15. In addition, various circuits (see FIG. 3) are mounted on substrate 15.

Antenna 101 is composed of: first antenna element 111 serving as a radiator at a center portion of antenna 101; and second and third antenna elements 112 and 113 serving as a wave conductor or a reflector at two sides of first antenna element 111, respectively.

The length of first antenna element 111 is ¼ of wavelength λ (λ/4). For example, when search apparatus 1 performs radio communication using 920 MHz, the length (λ/4) of first antenna element 111 is approximately 81.5 mm Second and third antenna elements 112 and 113 are identical in length and are shorter than first antenna element 111 in length.

Antenna elements 111, 112, and 113 are each composed of a folding pattern to be housed in a space of length H1 (e.g., 40 mm) and are each patterned on two sides of substrate 15 and connected within a through hole.

Recess portion 16 is provided at a center portion of rear surface 11f of case 11. When the user holds search apparatus 1 by hand so as to be able to press the buttons on operation section 13 with the first digit (thumb), the user can put the second digit (index finger) into recess portion 16 and thus can stably hold search apparatus 1.

### Structure of Search-Target Apparatus 2

Next, a description will be given of a structure of search-target apparatus 2 using

FIG. 2. FIG. 2 is an external view (front view) of search-target apparatus 2 according to Embodiment 1.

Search-target apparatus 2 is in size and weight that allow a user (standard individual) to carry around (for example, width W: 40 mm, height H: 63 mm, and thickness T: 13 mm and weight may be 20 g).

Case 21 of search-target apparatus 2 has a rectangular cube and is formed using a non-conductive member. Front surface 21a of case 21 is provided with light emitting diode (LED) 22 and power supply switch 23

LED 22 lights up (blinks) at a predetermined timing such as reception of a radio wave from search apparatus 1 in the individual search mode.

Case 21 houses an antenna (see FIG. 4) and a substrate (not illustrated) therein. In addition, various circuits (see FIG. 4) are mounted on the substrate.

Protruding portion 24 having hole 24a for inserting a string or the like therethrough is provided at a flat surface (upper end) of case 21. Connecting the string inserted through hole 24a to a cloth (e.g., belt) of the user prevents search-target apparatus 2 from separating from the user even when the user encounters an avalanche, for example.

### Circuit Configuration of Search Apparatus 1 (Block Diagram)

Next, a description will be given of a circuit configuration of search apparatus 1 using FIG. 3. FIG. 3 is a block diagram illustrating a configuration of search apparatus 1 according to Embodiment 1. Search apparatus 1 is mainly composed of case 11 (not illustrated in FIG. 3), display section 12, operation section 13, power supply switch 14 (not illustrated in FIG. 3), substrate 15 (not illustrated in FIG. 3), antenna 101, radio section 102, control section 103, sound section 104, and battery 105. Radio section 102 and control section 103 are mounted on substrate 15.

Radio section 102 performs radio signal processing. Radio section 102 includes transmission section 121, reception section 122, radio control section 123, first clock 124, first switch 125, second switch 126, and third switch 127.

Transmission section 121 applies radio transmission processing such as modulation, amplification, and/or up-conversion to a baseband digital signal output from CPU 131 and transmits a radio signal via first antenna element 111. The frequency of the radio wave (e.g., call signal) transmitted from transmission section 121 is equal to or greater than 710 MHz but not greater than 960 MHz.

Reception section 122 applies radio reception processing such as amplification, down-conversion, and/or demodulation to the radio signal received via first antenna element 111 and outputs a baseband digital signal to CPU 131. In addition, reception section 122 measures a received signal strength (RSSI: received signal strength indicator) of the radio wave received via first antenna element 111 and outputs a measurement value (analog value) to radio control section 123.

Radio control section 123 controls each section in radio section 102 using a clock signal of first clock 124. Radio control section 123 converts the measurement value of the received signal strength output from reception section 122 to a digital value and outputs the digital value to CPU 131. Note that, control for switches 125, 126, and 127 performed by radio control section 123 will be described hereinafter in detail.

First clock 124 is a high-speed and highly-accurate clock and generates a reference clock signal of a predetermined frequency (e.g., 36 MHz) to be used within radio section 102.

First switch 125 connects transmission section 121 or reception section 122 to first antenna element 111 in accordance with an indication of radio control section 123. Second switch 126 connects/disconnects between substrate 15 and second antenna element 112 in accordance with an indication of radio control section 123. Third switch 127 connects/disconnects between substrate 15 and third antenna element 113 in accordance with an indication of radio control section 123.

Control section 103 performs baseband signal processing. Control section 103 includes CPU 131, memory section 132, second clock 133, third clock 134, and logical operation unit 135.

CPU 131 is a central processing unit of control section 103 and executes various programs using memory section 132 as a working memory. In particular, CPU 131 generates a signal to be transmitted with respect to search-target apparatus 2, causes, upon reception of a radio wave from search-target apparatus 2, predetermined information thus acquired to be displayed on display section 12 and an alarm sound to be output from sound section 104.

Memory section 132 includes a read only memory (ROM) and a random access memory (RAM) and stores various programs to be executed by CPU 131, and various types of data.

Second clock 133 is a low speed clock and generates a reference clock signal of a predetermined frequency (e.g., 32 kHz) to be used within control section 103 during a standby state, for example. Third clock 134 is a high-speed and highly-accurate clock and generates a reference clock signal of a predetermined frequency (e.g., 40 MHz) to be used within control section 103 during a communication state with search-target apparatus 2, for example.

Logical operation section 135 calculates, in cooperation with CPU 131, a propagation delay time of a transmission path to search-target apparatus 2 based on a difference between a transmission timing of a transmission frame and a reference clock of third clock 134, a difference between a reception timing of a reception frame and a reference clock of third clock 134, as well as a difference between a transmission timing of a transmission frame and a reference clock of third clock 234 (see FIG. 4), and a difference between a reception timing of a reception frame and a reference clock of third clock 234 in search-target apparatus 2.

Sound section 104 outputs an alarm sound from a speaker at a predetermined timing such as a case where an indication from the user is received.

Battery 105 is housed in case 11, and when the user make an indication to turn ON the power supply via power supply switch 14, battery 105 supplies each section of search apparatus 1 with power.

### Functions of CPU 131

Next, a description will be given of functions of CPU 131 of search apparatus 1 using FIG. 3. CPU 131 includes signal generation section 131a, signal acquisition section 131b, distance estimation section 131c, and direction estimation section 131d as functions according to the present invention.

Signal generation section 131a generates a digital signal sequence (transmission frame) containing various types of information based on an indication of the user (electric signal input from operation section 13) and outputs the generated sequence to transmission section 121. In the individual search mode, signal generation section 131a includes, in the digital signal, identification information of single search-target apparatus 2 indicated by the user and identification information of search apparatus 1 of signal generation section 131a. In the all search mode, signal generation section 131a includes, in the digital signal, information indicating a request for transmission of a response signal to all search-target apparatuses 2. In the group search mode, signal generation section 131a includes, in the digital signal, identification information of all search-target apparatuses 2 belonging to a group indicated by the user. In the search-target mode, upon reception of information indicating a request for transmission of identification information of the search apparatus of signal generation section 131a from signal acquisition section 131b, signal generation section 131a includes, in the digital signal, identification information of the search apparatus of signal generation section 131a and identification information of search apparatus 1 which is the communication counterpart. Note that, in the individual search mode, signal generation section 131a may include, in the digital signal (response confirmation signal), information indicating lighting or outputting of an alarm sound with respect to search-target apparatus 2, based on an indication or the like from the user.

In a communication mode other than the search-target mode, signal acquisition section 131b acquires the identification information of search-target apparatus 2 from the digital signal sequence (reception frame) of the received response signal and outputs the identification information of search-target apparatus 2 to display section 12. In the search-target mode, signal acquisition section 131b acquires information from the digital signal sequence (reception frame) of the received call signal, and when the information indicates a request for transmission of the identification information of the search apparatus of signal acquisition section 131b, signal acquisition section 131b outputs the information to notify signal generation section 131a, accordingly. Note that, in the all search mode, signal acquisition section 131b may output to display section 12, from among the acquired pieces of identification information of search-target apparatuses 2, identification information of search-target apparatus 2 which corresponds to the largest received signal strength (1) or whose identification information matches the registered identification information (2), or all the pieces of identification information of search-target apparatuses 2 (3).

In the individual search mode, distance estimation section 131c estimates the distance to search-target apparatus 2 based on the received signal strength of the radio wave measured by reception section 122 or the propagation delay time calculated by logical operation section 135 and outputs the estimation value to display section 12. Note that, a detailed description of the distance estimation in Embodiment 1 will be given, hereinafter.

In the individual search mode, direction estimation section 131d estimates the direction of search-target apparatus 2 based on the received signal strength when second switch 126 is ON but third switch 127 is OFF, and the received signal strength when second switch 126 is OFF but third switch 127 is ON, and outputs the estimation value to display section 12. Note that, a detailed description of the direction estimation in Embodiment 1 will be given, hereinafter.

### Circuit Configuration of Search-Target Apparatus 2 (Block Diagram)

Next, a description will be given of a circuit configuration of search-target apparatus 2 using FIG. 4. FIG. 4 is a block diagram illustrating a configuration of search-target apparatus 2 according to Embodiment 1. Search-target apparatus 2 is mainly composed of case 21 (not illustrated in FIG. 4), LED 22, power supply switch 23 (not illustrated in FIG. 4), a substrate (not illustrated), antenna 201, radio section 202, control section 203, sound section 204, and battery 205.

Radio section 202 performs radio signal processing. Radio section 202 includes transmission section 221, reception section 222, radio control section 223, first clock 224, and first switch 225.

Transmission section 221 applies radio transmission processing such as modulation, amplification, and/or up-conversion to a baseband digital signal output from CPU 231 and transmits a radio signal via antenna element 201. The frequency of the radio wave (e.g., response signal) transmitted from transmission section 221 is equal to or greater than 770 MHz but not greater than 960 MHz.

Reception section 222 applies radio reception processing such as amplification, down-conversion, and/or demodulation to the radio signal received via antenna element 201 and outputs a baseband digital signal to CPU 231.

Radio control section 223 controls each section in radio section 202 using a clock signal of first clock 224.

First clock 224 is a high-speed and highly-accurate clock and generates a reference clock signal of a predetermined frequency (e.g., 36 MHz) to be used within radio section 202.

First switch 225 connects transmission section 221 or reception section 222 to antenna 201 in accordance with an indication of radio control section 223.

Control section 203 performs baseband signal processing. Control section 203 includes CPU 231, memory section 232, second clock 233, and third clock 234.

CPU 231 is a central processing unit of control section 203 and executes various programs using memory section 232 as a working memory. In particular, CPU 231 generates a signal to be transmitted with respect to search apparatus 1, and upon reception of a radio wave from search apparatus 1 or an indication from search apparatus 1, CPU 231 causes LED 22 to light and an alarm sound to be output from sound section 204.

Memory section 232 includes a read only memory (ROM) and a random access memory (RAM) and stores various programs to be executed by CPU 231, and various types of data.

Second clock 233 is a low speed clock and generates a reference clock signal of a predetermined frequency (e.g., 32 kHz) to be used within control section 203 during a standby state, for example. Third clock 234 is a high-speed and highly-accurate clock and generates a reference clock signal of a predetermined frequency (e.g., 40 MHz) to be used within control section 203 during a communication state with search apparatus 1, for example.

Sound section 204 outputs an alarm sound from a speaker at a predetermined timing upon reception of a radio wave from search apparatus 1.

Battery 205 is housed in case 21, and when the user makes an indication to turn ON the power supply via power supply switch 23, battery 205 supplies each section of search-target apparatus 2 with power.

### Functions of CPU 231

Next, a description will be given of functions of CPU 231 of search-target apparatus 2 using FIG. 4. CPU 231 includes signal generation section 231a and signal acquisition section 231b as functions according to the present invention.

Upon reception of information indicating a request for transmission of the identification information of search-target apparatus 2 of signal generation section 231a from signal acquisition section 231b, signal generation section 231a generates a digital signal sequence (transmission frame) containing the identification information of search-target apparatus 2 and identification information of search apparatus 1 which is the communication counterpart and outputs the generated sequence to transmission section 221.

Signal acquisition section 231b acquires information from a digital signal sequence (reception frame) of the received call signal, and when the information indicates a request for transmission of identification of search-target apparatus 2 of signal acquisition section 231b, signal acquisition section 231b outputs the information to notify signal generation section 231a, accordingly. In addition, upon reception of a radio wave from search apparatus 1 or an indication from search apparatus 1, signal acquisition section 231b causes LED 22 to light and an alarm to be output from sound section 204.

### Communication Sequence of Individual Search Mode

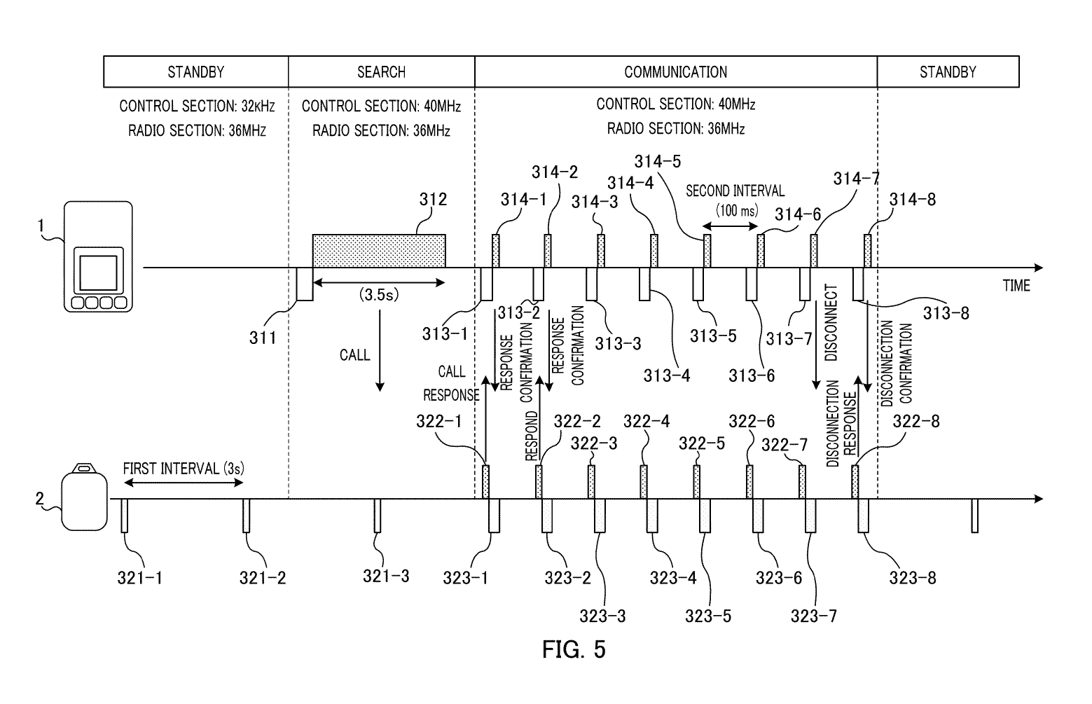

Next, a description will be given of how search apparatus 1 and search-target apparatus 2 according to Embodiment 1 communicate with each other in the individual search mode, using a sequence diagram of FIG. 5.

Search apparatus 1 enters the standby state after the power supply is turned ON until an indication is given from the user (button operation of operation section 13). During the standby state, no power is supplied to each section of search apparatus 1 in order to reduce power consumption (sleep state). However, operation section 13 and second clock 133 are supplied with power from battery 105. Second clock 133 runs a low speed clock circuit to perform a count operation all the time.

Search-target apparatus 2 enters the standby state after the power supply is turned ON. During the standby state, no power is supplied to each section of search-target apparatus 2 in order to reduce power consumption (sleep state). However, second clock 233 is supplied with power from battery 205. Second clock 233 runs a low speed clock circuit to perform a count operation all the time.

Search-target apparatus 2 supplies power to each section (active state) every first interval (e.g., 3 s) until the count value of second clock 233 expires. During the active state, search-target apparatus 2 performs reception processing in first period 321 (e.g., 3 ms). At this time, first clock 224 runs a clock circuit to perform a count operation.

Search-target apparatus 2 returns to the sleep state in a case where search-target apparatus 2 has not been able to acquire information indicating a request for transmission of identification information of search-target apparatus 2 during first period 321.

During the standby state, when identification information of search-target apparatus 2, which is the search-target, is indicated by the user, search apparatus 1 supplies power to each section and starts a search for search-target apparatus 2 (search state). At this time, first clock 124 and third clock 134 run a high-speed clock circuit to perform a count operation.

Search apparatus 1 which has entered the search state first performs reception processing in second period 311 (e.g., 5 ms) in order to confirm that another search apparatus 1 transmits no radio wave. When receiving no radio wave from another search apparatus 1 during second period 311, search apparatus 1 repeatedly transmits a call signal containing identification information of search apparatus 1, identification information of search-target apparatus 2, which is the search-target, and timing information indicating transmission timing of a response signal with respect to search-target apparatus 2, in third period 312 (e.g., 3.5 s), which is longer than the first interval.

Upon reception of a call signal during any one of first periods 321-3, search-target apparatus 2 starts communication with search apparatus 1 (communication state). At this time, third clock 234 runs a high-speed clock circuit to perform a count operation. In fourth period 322-1 (e.g., 2 ms) indicated by the timing information contained in the call signal, search-target apparatus 2 transmits a response signal containing the identification information of search target apparatus 2, the identification information of search apparatus 1, which is the communication counterpart, and distance information (a difference between the transmission timing of the transmission frame and the reference clock of third clock 234, and a difference between the reception timing of the reception frame and the reference clock of third clock 234) (note that, the response signal to be transmitted for the first time after reception of a call signal is referred to as “call response signal” in the description to be given hereinafter).

Search apparatus 1 performs reception processing in fifth period 313 (e.g., 3 ms). Upon reception of a call response signal, search apparatus 1 right away transmits a response confirmation signal containing the identification information of search apparatus 1 and the identification information of search-target apparatus 2, which is the search target, in sixth period 314-1 (e.g., 2 ms). Note that, the baseband frequency of the response confirmation signal is different from that of the call signal. For this reason, even when receiving the response confirmation signal and the call signal from another search apparatus 1 at the same time, search-target apparatus 2 causes no interference.

Search-target apparatus 2 performs reception processing in seventh period 323-1 (e.g., 3 ms) right after fourth period 322-1. Upon reception of a response confirmation signal, search-target apparatus 2 transmits again a response signal in fourth period 322-2 after a second interval (e.g., 100 ms), which is shorter than the first interval, elapses.

Subsequently, until a disconnection indication is made by the user, the communication system repeats transmission/reception of a response signal and transmission/reception of a response confirmation signal. Search apparatus 1 estimates, every time receiving a response signal, the distance and direction of search-target apparatus 2 using the response signal, and causes the identification information of search-target apparatus 2 and information on the distance and direction of search-target apparatus 2 to be displayed on a screen of display section 12.

When a disconnection indication is made by the user, search apparatus 1 transmits a disconnection signal containing the identification information of search apparatus 1, the identification information of search-target apparatus 2, which is the search target, and information indicating transmission disconnection with respect to this search-target apparatus 2, in subsequent sixth period 314-7.

Upon reception of the disconnection signal in corresponding seventh period 323-7, search-target apparatus 2 transmits a disconnection response signal containing the identification information of search-target apparatus 2, the identification information of search apparatus 1, which is the communication counterpart, and information indicating reception of the disconnection signal, in subsequent fourth period 322-8.

In subsequent sixth period 314-8, search apparatus 1 transmits a disconnection confirmation signal containing the identification information of search apparatus 1, the identification information of search-target apparatus 2, which is the search target, and information indicating reception of the disconnection response signal, and returns to the standby state. Search-target apparatus 2 returns to the standby state upon reception of the disconnection confirmation signal in subsequent seventh period 323-8.

### Communication Sequence of All Search Mode (Group Search) Mode

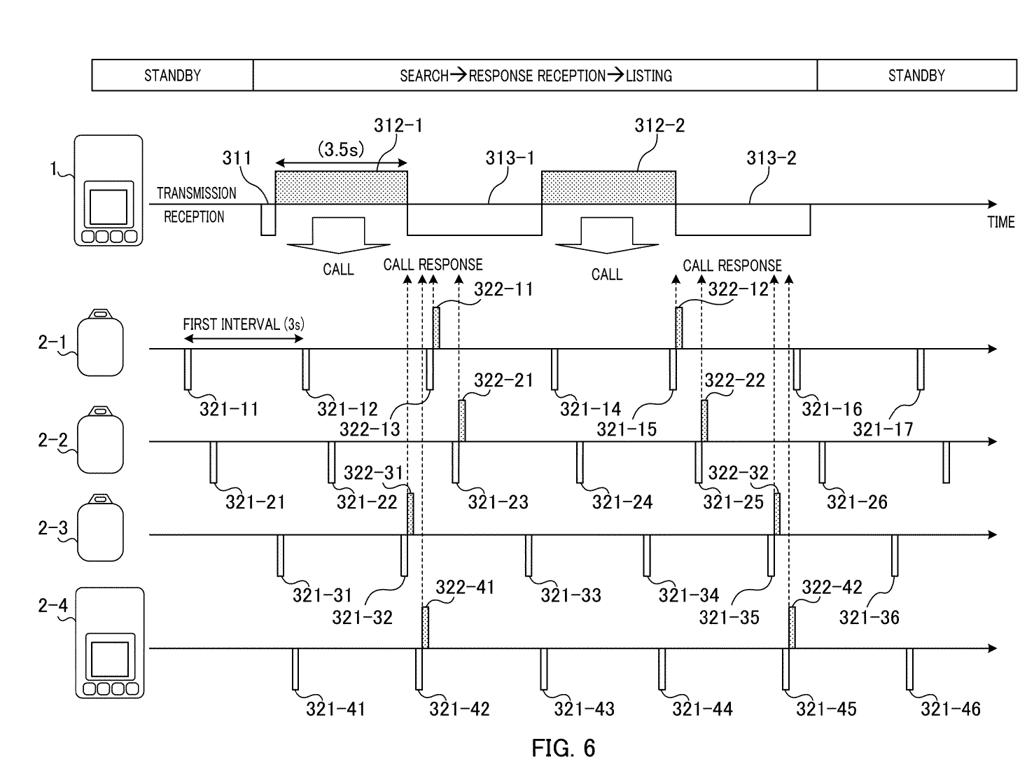

Next, a description will be given of how search apparatus 1 and search-target apparatus 2 according to Embodiment 1 communicate with each other in the all search mode, using a sequence diagram of FIG. 6. Note that, the sequence of the group search mode is the same as that of the all search mode. In addition, how search apparatus 1 and search-target apparatus 2 operate is the same in all the communication modes, and has been already described using FIG. 5, so that the description thereof is omitted herein.

In FIG. 6, an assumption is made that four search-target apparatuses 2 (2-1, 2-2, 2-3, and 2-4) exist within a coverage area of a radio wave of search apparatus 1.

In the all search mode, search apparatus 1 in a communication state first performs reception processing in second period 311 (e.g., 5 ms) in order to confirm that another search apparatus 1 transmits no radio wave. When no radio wave has been received from another search apparatus 1 in second period 311, search apparatus 1 repeatedly transmits a call signal containing information indicating a request for transmission of identification information with respect to all search-target apparatuses 2, in third period 312 (e.g., 3.5 s), which is longer than the first interval.

When each search-target apparatus 2 receives a call signal in any one of first periods 321-12, 321-22, 321-31, and 321-41, search-target apparatus 2 transmits a call response signal containing the identification information of search-target apparatus 2 in fourth period 322 after the first interval time elapses from the start of this first period 321.

After the expiration of third period 312, search apparatus 1 receives a call response signal in fifth period 313 (e.g., 3.5 s), which is longer than the first interval.

Subsequently, the communication system repeats transmission/reception of a call signal and transmission/reception of a call response signal a predetermined number of times N. Search apparatus 1 causes the identification information of search-target apparatus 2 which is contained in the received call response signal to be displayed on a screen of display section 12. Search apparatus 1 and search-target apparatuses 2 return to the standby state thereafter.

### Distance Estimation

Next, a description will be given of a method of estimating a distance to search-target apparatus 2 by search apparatus 1 according to Embodiment 1. As a distance estimation method in the field of radio communications, a first distance estimation method based on a received signal strength, and a second distance estimation method based on a propagation delay time have been known.

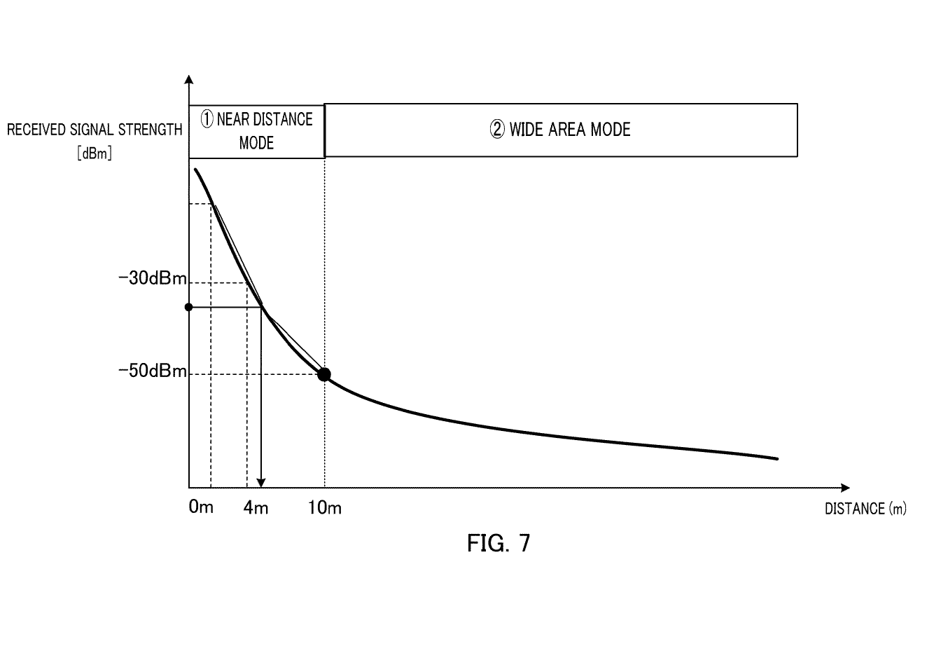

FIG. 7 is a diagram illustrating a relationship between a distance and a received signal strength. In FIG. 7, the horizontal axis represents distance (m) and the vertical axis represents received signal strength (dBm). As illustrated in FIG. 7, there is a correlation between the distance and received signal strength, and the longer the distance is, the lower the received signal strength will be. The first distance estimation method is a method of estimating a distance using the correlation between this distance and the received signal strength.

As illustrated in FIG. 7, the longer the distance is, the smaller the amount of change in received signal strength in distance units will be. Accordingly, search apparatus 1 can accurately estimate a distance using the first distance estimation method when the distance to search-target apparatus 2 is short. Meanwhile, when the distance to search-target apparatus 2 is long, the variation in radio wave becomes moderate, so that the distance cannot be accurately estimated when the first distance estimation method is used.

The second distance estimation method is a method of estimating a distance by multiplying the calculated propagation delay time by the speed of radio wave. The estimation accuracy of the second distance estimation method is substantially constant regardless of the distance. Moreover, when the distance to search-target apparatus 2 is long, the high level of estimation accuracy is not required as compared with the case where the distance is short.

In view of the points mentioned above, distance estimation section 131c of search apparatus 1 according to Embodiment 1 estimates the distance to search-target apparatus 2 using the first distance estimation method based on the received signal strength when the measured received signal strength is greater than a predetermined threshold (e.g., −50 dBm) (near distance mode), and when the measured received signal strength is not greater than the predetermined threshold (wide area mode), distance estimation section 131c of search apparatus 1 according to Embodiment 1 estimates the distance to search-target apparatus 2 using the second distance estimation method based on the propagation delay time.

Note that, in Embodiment 1, it is possible to use hysteresis control to switch between the estimation methods, and a first threshold for switching from the first distance estimation method to the second distance estimation method and a second threshold (>first threshold) for switching from the second distance estimation method to the first distance estimation method may be set. Thus, it is made possible to prevent the estimated distance goes up and down significantly in a short time because switching between the estimation methods occurs frequently.

In addition, in Embodiment 1, it is possible to switch from the first distance estimation method to the second distance estimation method based on a magnitude relationship between the received signal strength and a third threshold, and switching from the second distance estimation method to the first distance estimation method may be performed based on a magnitude relationship between the propagation delay time and a fourth threshold.

### Antenna Control and Direction Estimation

Next, a description will be given of control of antenna 101 and an estimation method for a direction of search-target apparatus 2 by search apparatus 1 according to Embodiment 1.

Radio control section 123 controls first switch 125 to connect first antenna element 111 and reception section 122, when receiving a radio wave (response signal).

In the individual search mode, radio control section 123 turns ON second switch 126 to connect between substrate 15 and second antenna element 112 and turns OFF third switch 127 to disconnect between substrate 15 and third antenna element 113, in a first part period of a radio wave (response signal) receiving period.

Second antenna element 112 and substrate 15 connected to each other become longer as a whole than first antenna element 111 (radiator) by this control and thus acts as a reflector. In addition, third antenna element 113 becomes shorter than first antenna element 111 (radiator) and thus acts as a director.

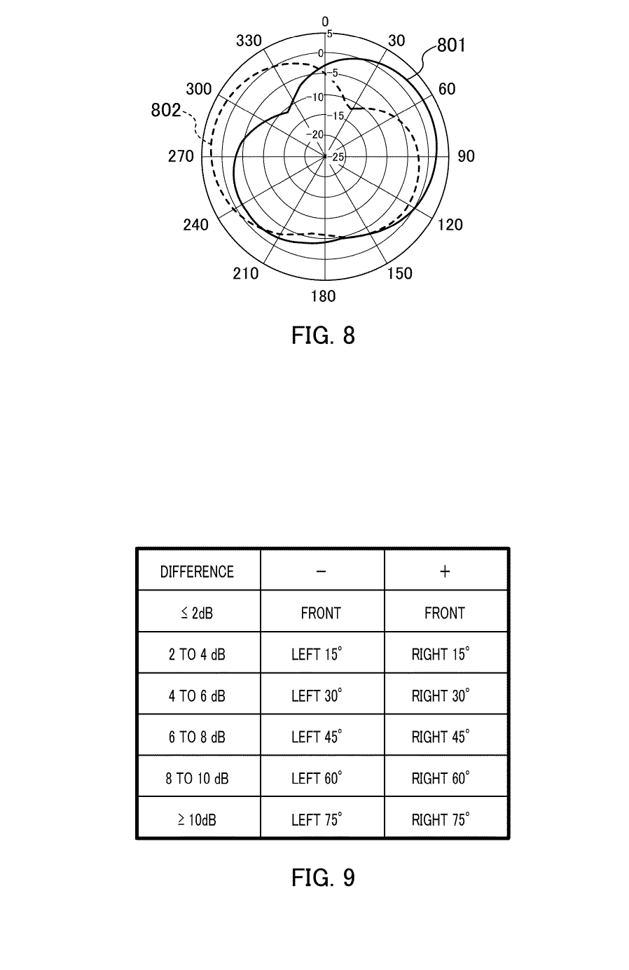

As a result, first reception directivity 801 of FIG. 8 is formed in the first part period. During this period, when the user holds search apparatus 1 substantially horizontally with the side of flat surface 11e (upper end side) facing forward, search apparatus 1 can receive a radio wave intensively from a right oblique forward direction.

In addition, radio control signal 123 turns OFF second switch 126 to disconnect between substrate 15 and second antenna element 112 and turns ON third switch 127 to connect between substrate 15 and third antenna element 113 in a second part period of the radio wave (response signal) reception period.

Third antenna element 113 and substrate 15 connected to each other become longer as a whole than first antenna element 111 (radiator) by this control and thus acts as a reflector. In addition, second antenna element 112 becomes shorter than first antenna element 111 (radiator) and thus acts as a director.

As a result, second reception directivity 802 of FIG. 8 is formed in the second part period. During this period, when the user holds search apparatus 1 substantially horizontally with the side of flat surface 11e (upper end side) facing forward, search apparatus 1 can receive a radio wave intensively from a left oblique forward direction.

When search-target apparatus 2, which is the search-target, exists on the right side of the user, the received signal strength in the first part period becomes higher than the received signal strength in the second part period. Reversely, when search-target apparatus 2, which is the search-target, exists on the left side of the user, the received signal strength in the first part period becomes lower than the received signal strength in the second part period.

Thus, according to this embodiment, the direction of search-target apparatus 2 can be estimated based on the degree of difference in received signal strength between the first part period and the second part period and a magnitude relationship.

Note that, during the radio wave transmission of the individual search mode, the all search mode, the group search mode, and the search-target mode, radio control section 123 turns OFF second switch 126 and third switch 127, and search apparatus 1 may perform non-directivity transmission and reception.

In Embodiment 1, memory section 132 stores an information table indicating the estimated directions based on the degrees of differences in received signal strength and their signs (magnitude relationship) as illustrated in FIG. 9. Direction estimation section 131d estimates the direction of search-target apparatus 2 based on the received signal strengths measured in the first and the second part periods, respectively, and with reference to the information table in FIG. 9, and outputs the estimation result to display section 12.

Note that, direction estimation section 131d may average the received signal strengths measured a plurality of times and estimate the direction of search-target apparatus 2 using the average value. Thus, the influence of the propagation path variations can be absorbed.

### Display Screen

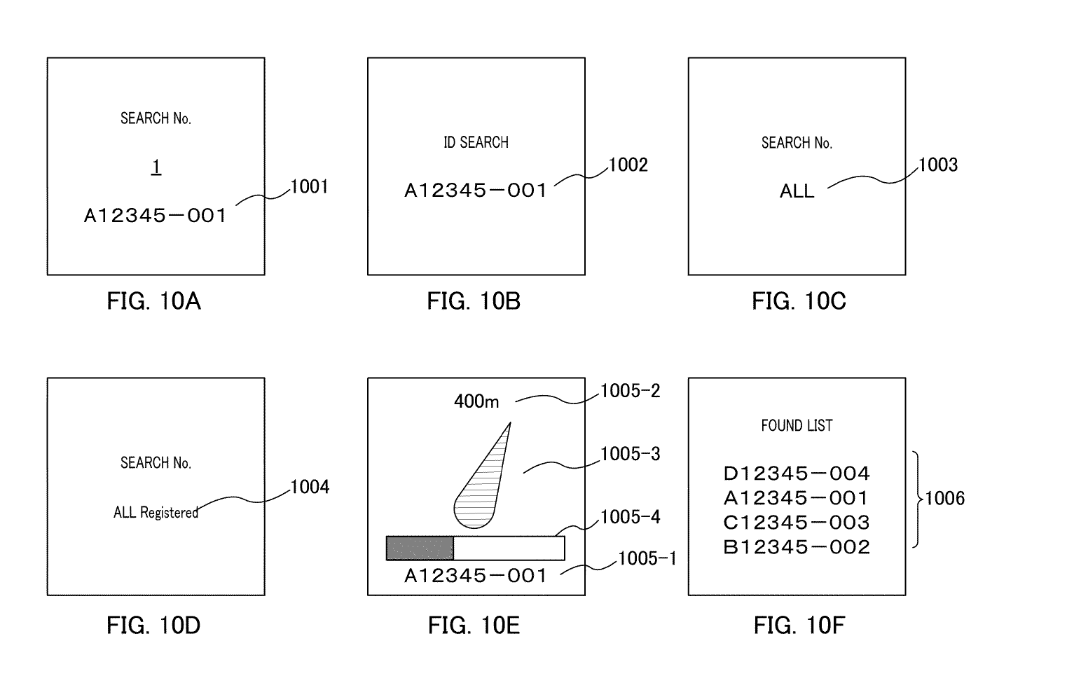

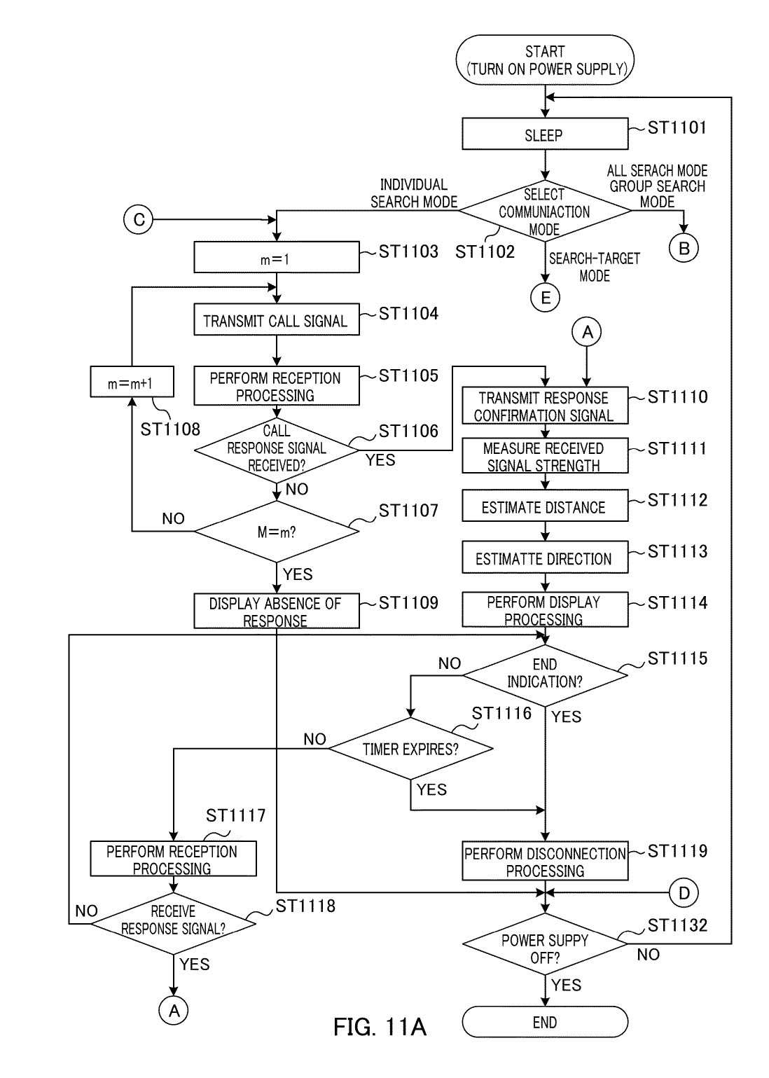

Next, a description will be given of information to be displayed on a screen of the search apparatus according to Embodiment 1 using FIGS. 10A to 10F.

FIG. 10A illustrates a screen at start of the individual search mode when a search for already registered search-target apparatus 2 is started. On this screen, identification number (identification information) 1001 of search-target apparatus 2, which is the search-target, is displayed together with the registration number. When a search execution is indicated by the user in this display state, search apparatus 1 executes the individual search mode for search-target apparatus 2 whose identification number is displayed on the screen.

FIG. 10B illustrates a screen at start of the individual search mode when a search for unregistered search-target apparatus 2 is started. On this screen, part 1002 where input of the identification number (identification information) of search-target apparatus 2, which is the search target, is displayed. When a search execution is indicated by the user in this display state after completion of the input of identification number, search apparatus 1 executes the individual search mode (see FIG. 5) for search-target apparatus 2 whose identification number is displayed on the screen.

FIG. 10C illustrates a screen at start of the all search mode. On this screen, letter 1003 of “ALL” is displayed. When a search execution is indicated by the user in this display state, search apparatus 1 executes the all search mode (see FIG. 6).

FIG. 10D illustrates a screen at start of the group search mode. On this screen, letter 1004 of “ALL Registered” is displayed. When a search execution is indicated by the user in this display state, search apparatus 1 executes the group search mode for previously registered all search-target apparatuses 2 (see FIG. 6).

FIG. 10E illustrates a screen when the individual search mode is executed, and a response signal is received from search-target apparatus 2. On this screen, the following information is displayed: identification information 1005-1 of search-target apparatus 2 which has responded; information 1005-2 on the distance to search-target apparatus 2; information 1005-3 on the direction of search-target apparatus 2; and information 1005-4 indicating a received signal strength, for example.

Note that, in this embodiment, updating of information 1005-3 on the direction of search-target apparatus 2 is limited to one step each. For example, when the result of the last direction estimation is left 75 degrees and the result of the subsequent direction estimation is 30 degrees, information indicating left 60 degrees, which corresponds to the estimation that has been made one step closer to right 30 degrees from left 75 degrees by one step (15 degrees) is displayed on the screen. Thereafter, when the results of the direction estimation are right 30 degrees in a row, pieces of information respectively indicating left 45 degrees, left 30 degrees, left 15 degrees, 0 degrees, right 15 degrees, and right 30 degrees are sequentially displayed on the screen. Thus, the influence of temporary and drastic variations in the estimated direction due to interception of radio waves, for example, can be absorbed. In addition, the directivity in FIG. 8 is to vary depending how the user holds search apparatus 1, for example, so that the direction estimated from a received signal strength does not necessarily match the actual direction of search-target apparatus 2, but the direction estimation of Embodiment 1 makes it possible to roughly estimate the direction of search-target apparatus 2 and is effective enough.

FIG. 10F illustrates a screen when the all search mode or group search mode is executed, and a call response signal is received from search-target apparatus 2. On this screen, pieces of identification information 1006 of all found search-target apparatuses 2 are displayed. At this time, pieces of identification information 1006 of search-target apparatuses 2 are displayed in descending order of received signal strengths from above.

### Description of Flow

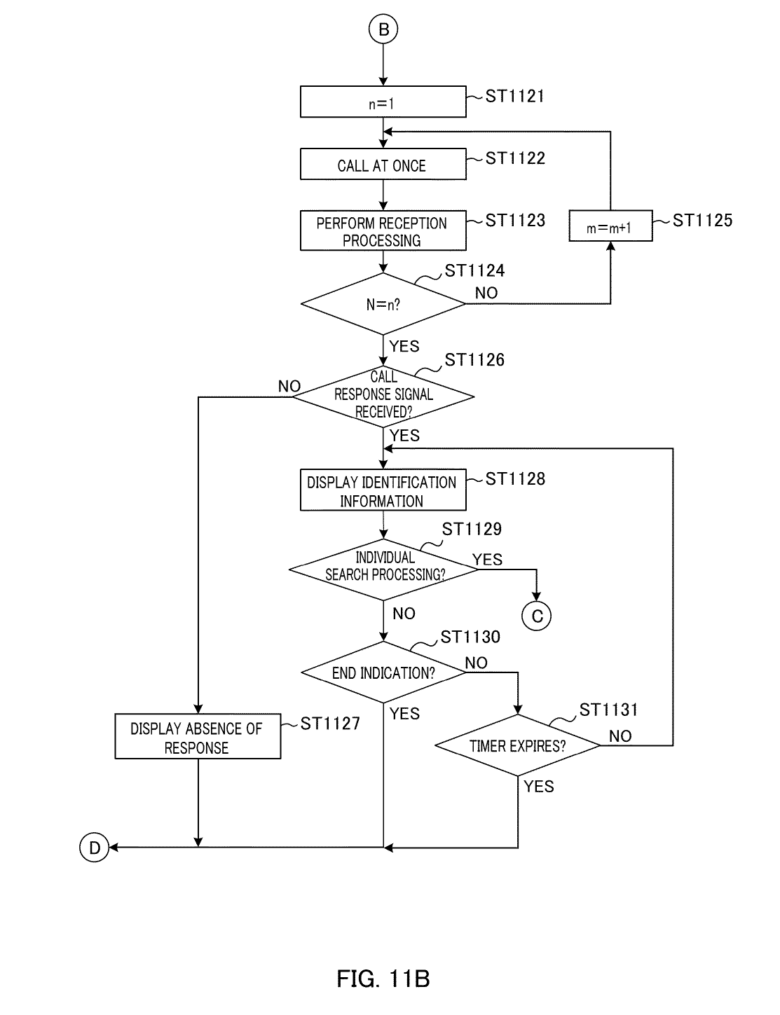

Next, a description will be given of an operation flow of search apparatus 1 according to Embodiment 1 using FIGS. 11A and 11B.

Search apparatus 1 enters the sleep state when the power supply is turned ON (ST 1101) and wait for an indication from the user in this state (ST 1102).

When the indication from the user is the individual search mode (ST 1102: individual search mode), search apparatus 1 transmits a call signal to search-target apparatus 2, which is the search-target (ST 1103 and ST 1104). Search apparatus 1 performs reception processing at a timing indicated to search-target apparatus 2 in the call signal (ST 1105).

When no call response signal is successfully received in ST 1105 (ST 1106: NO), search apparatus 1 repeats the steps from ST 1104 to ST 1106 (ST 1107: NO, ST 1108). When no call response signal is successfully received even after transmission of the call signal M times (ST 1107: YES), search apparatus 1 displays a message indicating that no response has been received on the screen of display section 12 (ST 1109). The flow then proceeds to ST 1132.

In a case where a call response signal is successfully received in ST 1105 (ST 1106: YES), search apparatus 1 right away transmits a response confirmation signal to search-target apparatus 2 (ST 1110). In addition, search apparatus 1 measures the received signal strength of the response signal (ST 1111), estimates the distance to search-target apparatus 2 (ST 1112), and estimates the direction of search-target apparatus 2 (ST 1113). Search apparatus 1 displays the identification information of search-target apparatus 2 and information on the distance and direction of search-target apparatus 2 on the screen of display section 12 (ST 1114).

When no search end indication is given from the user (ST 1115: NO), and the timer that counts a predetermined time has not expired (ST 1116: NO), search apparatus 1 performs again reception processing at predetermined intervals (ST 1117).

When no response signal is successfully received in ST 1117 (ST 1118: NO), search apparatus 1 repeats the steps from ST 1115 to ST 1117. Meanwhile, when a response signal is successfully received in ST 1117 (ST 1118: YES), the flow returns to ST 1110, and search apparatus 1 repeats the steps from ST 1100 to ST 1117 (communication state).

In this communication state, when a search end indication is given from the user (ST 1115: YES), or when the timer that counts a predetermined time has expired (ST 1116: YES), search apparatus 1 performs disconnection processing of disconnection signal transmission, disconnection response signal reception and disconnection confirmation signal transmission (ST 1119). The flow then advances to ST 1132.

In ST 1102, when the indication from the user is the all search mode or group search mode (ST 1102: all search mode, group search mode), search apparatus 1 transmits a call signal to all search-target apparatuses 2 or all previously-registered search-target apparatuses 2 at once (ST 1121, ST 1122) and performs reception processing over a predetermined period (ST 1123). Search apparatus 1 repeats the steps of ST 1122 and ST 1123 N times (ST 1124, ST 1125).

When not even one response signal is successfully received in N times of ST 1123 (ST 1126: NO), search apparatus 1 displays a message indicating that no response has been received on the screen of display section 12 (ST 1127). The flow then proceeds to ST 1132.

When at least one response signal is successfully received in N times of ST 1123 (ST 1126: YES), search apparatus 1 displays the identification information of search-target apparatus 2 on the screen of display section 12 (ST 1128).

When no indication to shift to the individual search mode or no search end indication is given from the user (ST 1129: NO, ST 1130: NO), and the timer that counts a predetermined time has not expired either (ST 1131: NO), search apparatus 1 repeats the step of ST 1128.

After ST 1128, when an indication to shift to the individual search mode is given (ST 1129: YES), the flow moves to ST 1103. In addition, when a search end indication is given from the user (ST 1130: YES), or the timer that counts a predetermined time expires (ST 1131: YES), the flow moves to ST 1132.

In ST 1132, when the power supply is not turned OFF (ST 1132: NO), the flow returns to ST 1101. Meanwhile, when the power supply is turned OFF in ST 1132 (ST 1132: YES), the flow ends.

Note that, when the indication from the user is the search-target mode in ST 1102 (ST 1102: search-target mode), the flow proceeds to ST 1201 and search apparatus 1 operates as search-target apparatus 2.

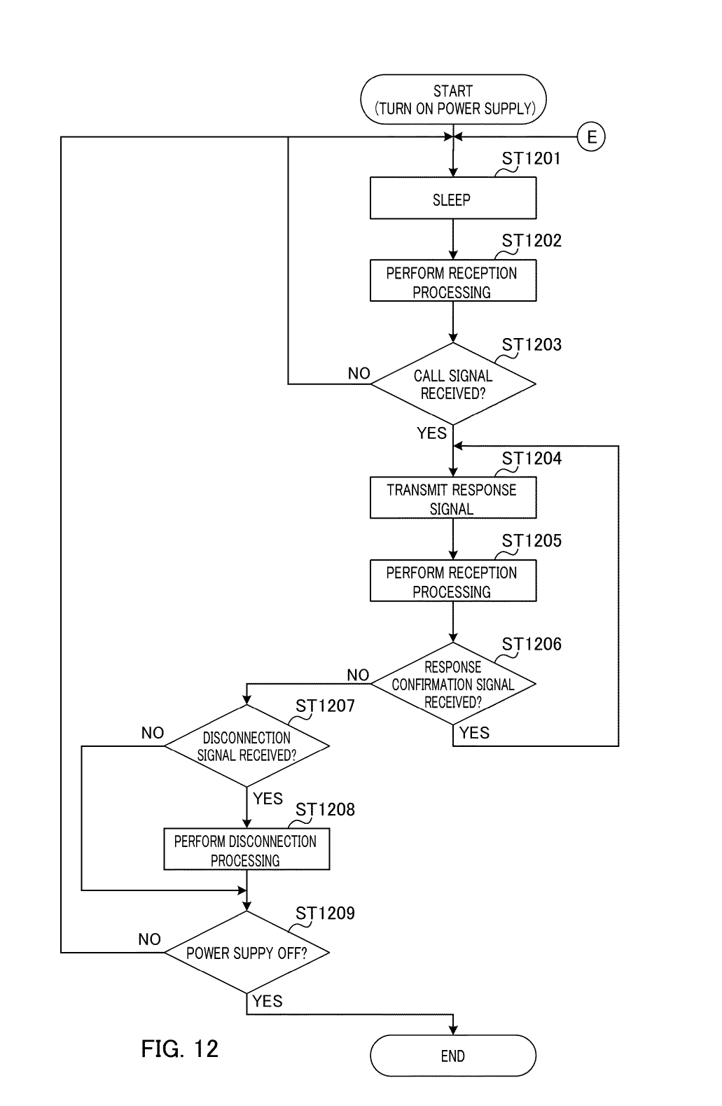

Next, a description will be given of an operation flow of search-target apparatus 2 according to Embodiment 1 using FIG. 12.

Search-target apparatus 2 enters the sleep state when the power supply is turned ON (ST 1201) and periodically (at first intervals) performs reception processing (ST 1202).

In a case where no call signal is successfully received in ST 1202 (ST 1203: NO), search-target apparatus 2 returns to the sleep state in ST 1201.

In a case where a call signal is successfully received in ST 1202 (ST 1203: YES), search-target apparatus 2 transmits a response signal to search apparatus 1 at the indicated timing (ST 1204) and right away performs reception processing (ST 1205).

In a case where a response confirmation signal is successfully received in ST 1205 (ST 1206: YES), search-target apparatus 2 transmits again a response signal to search apparatus 1 after a predetermined time (second interval) elapses (ST 1204). Subsequently, in a case where a response confirmation signal is successfully received (ST 1206: YES), the steps of ST 1204 and ST 1205 are repeated.

In a case where no response confirmation signal is received in ST 1205 (ST 1206: NO), but a disconnection signal is received (ST 1207: YES), search-target apparatus 2 performs disconnection processing of disconnection response signal transmission and disconnection confirmation signal reception (ST 1208). The flow then proceeds to ST 1209.

In a case where neither response confirmation signal nor disconnection signal is received in ST 1205 (ST 1206: NO, ST 1207: NO), the flow proceeds to ST 1209.

In ST 1209, when the power supply is not turned OFF (ST 1209: NO), the flow returns to ST 1201. Meanwhile, when the power supply is turned OFF in ST 1209 (ST 1209: YES), the flow ends.

### Effects

As has been described above, according to Embodiment 1, search-target apparatus 2 does not have to always transmit a periodical signal such as a beacon and only needs to transmit a response signal upon reception of a call signal from search apparatus 1. Thus, the power consumption of search-target apparatus 2 is reduced as compared with the apparatus of the related art. For this reason, search-target apparatus 2 is capable of continuously operating for a long period (e.g., three months or more) and thus involves no concern for running out of a battery until the user descends from the mountain even when the user previously turns ON the power supply such as when the user enters the mountain area. Moreover, when the user previously turns ON the power supply, search-target apparatus 2 can perform radio communication with search apparatus 1 without the need for any additional user operation. For this reason, even when the user loses consciousness because of an avalanche or the like, search apparatus 1 can identify the position of search-target apparatus 2.

Search apparatus 1 and search-target apparatus 2 perform radio communication using a frequency of 710 MHz or higher but not higher than 960 MHz, so that the radio wave receivable distance of search-target apparatus 2 for a radio wave from search apparatus 1 is long, and search apparatus 1 is thus capable of conducting a wide area search (e.g., 100 m to 5 km). Note that, the use of an even higher frequency such as 2.4 GHz in WLAN reduces the antenna in length and reduces the receivable distance. Moreover, the use of an even higher frequency causes an increase in straightness of radio waves and reduction in wrap-around characteristics, so that the possibility of finding a lost climber or the like in an environment with obstacles is reduced. Meanwhile, the use of a lower frequency causes an increase in length of the antenna, thus causing an increase in size of the apparatus.

Moreover, the use of the distance measurement method of Embodiment 1 enables, when search-target apparatus 2 is in a near distance area, search apparatus 1 to estimate the relative distance to search-target apparatus 2 with high accuracy, and when search-target apparatus 2 is not in a near distance area, the use of the method enables search apparatus 1 to estimate the relative distance to search-target apparatus 2 with predetermined accuracy.

Moreover, the use of the antenna structure and switching control of Embodiment 1 makes it possible to reduce the circuit scale of an antenna portion and thus to reduce the size and weight of the entirety of the apparatus, as compared with a case where an array antenna is used. In first antenna element 111 (radiator) which receives radio waves, no switching of directivity is performed, so that the switching loss becomes the minimum. In addition, the switching timings of second switch 126 and third switch 127 are the same, so that only one control system is used for switching the switches.

In addition, providing recess portion 16 at the center portion of rear surface 11f of case 11 of search apparatus 1 of Embodiment 1 allows, when the user holds search apparatus 1 by hand so as to be able to press the buttons of operation section 13 with the first digit (thumb), the user to put the second digit (index finger) into recess portion 16 to stably hold search apparatus 1. In addition, this way of holding the apparatus does not involve fingers or hand around antenna element 111, 112, or 113, so that the influence on the antenna directivity is prevented, and the direction estimation accuracy can be stable.

In addition, search-target apparatus 2 of Embodiment 1 causes LED 22 to light and an alarm sound to be output from sound section 204 upon reception of a radio wave from search apparatus 1 or an indication from search apparatus 1. Thus, the user of search apparatus 1 can search for search-target apparatus 2 using his or her own visual or auditory perception.

According to Embodiment 1, the possibility of finding a lost mountain climber or the like further increases, and a further reduction in the time required for finding the lost mountain climber can be expected.

Note that, in Embodiment 1, a description has been given of the case where search-target apparatus 2 always transmits a call response signal upon reception of a call signal from search apparatus 1, but the present invention is not limited to this case, and search-target apparatus 2 may previously store identification information of predetermined search apparatus 1, and upon reception of a call signal from search apparatus 1, search-target apparatus 2 may transmit a call response signal only when the stored pieces of identification information of search apparatuses 1 include one that matches the piece of identification information of search apparatus 1 included in this call signal.

Thus, search apparatus 1 can cause only identification information of search-target apparatus 2 in which the identification information of search apparatus 1 has been registered. Moreover, search-target apparatus 2 can save power consumption because the number of times search-target apparatus 2 transmits a response signal is reduced.

Furthermore, in Embodiment 1, a description has been given of the case where information on the estimated distance and direction of search-target apparatus 2 on the screen of an LCD or the like of search apparatus 1, but the present invention is not limited to this case, and another display method may be used. For example, a plurality of LEDs may be provided at the front surface of case 11 of search apparatus 1, and the position of the LED to light may be changed according to the distance and direction of search-target apparatus 2, for example.

In addition, in Embodiment 1, a description has been given of the case where identification information of search-target apparatus 2 is displayed on the screen of search apparatus 1, but the present invention is not limited to this case, and search apparatus 1 may include a speaker, for example, and the identification information of search-target apparatus 2 may be output as audio from this speaker.

In Embodiment 1, a description has been given of the case where recess portion 16 is provided at the center portion of rear surface llf of case 11 of search apparatus 1 to prevent any influence on the antenna directivity, but the present invention is not limited to this case, and it is also possible to prevent hands or fingers from being around antenna element 111, 112, or 113 by another configuration such as providing a protruding portion at a position relatively closer to the side of fat panel 11e (upper end side) with respect to the center of rear surface 11f.

### Embodiment 2

In a snow mountain or the like, a search for a lost climber is usually conducted in units of teams each composed of a plurality of members. In this case, it is important that rescue activities be conducted while each member of the team promptly notifies other members of information such as one indicating that the member has found the lost climber, to share such information within the team.

In Embodiment 2, a description will be given of an application example of a search apparatus in case where a search is conducted by a team. Note that, a search apparatus and a search-target apparatus in Embodiment 2 are configured in a manner similar to those described in Embodiment 1, so that the description of the configurations will be omitted.

### Description of Use State

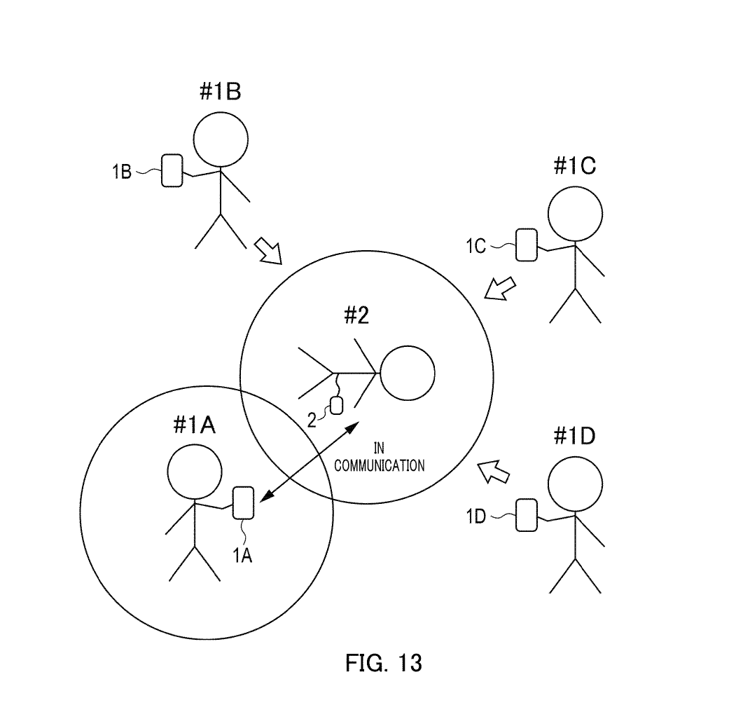

FIG. 13 is a diagram illustrating an exemplary use state of a search apparatus according to Embodiment 2. FIG. 13 illustrates an example in which four searchers #1A, #1B, #1C, and #1D belonging to a single team use search apparatuses 1A, 1B, 1C, and 1D, respectively, and conduct a search for search-target #2 provided with search-target apparatus 2. In addition, an assumption is made that search-target apparatus 2 transmits a response signal to search apparatus 1A carried by searcher #1A, and search apparatus 1A is in communication with search-target apparatus 2.

In this case, in Embodiment 2, searchers #1B, #1C, and #1D other than searcher #1A can know that search apparatus 1A of searcher #1A has received a response signal from search-target apparatus 2 of search-target #2, via search apparatuses 1B, 1C, and 1D carried by searchers #1B, #1C, and #1D, respectively. More specifically, in Embodiment 2, each member can easily find out that one member of the team has successfully communicated with the search-target apparatus of the search-target without using another communication means. Hereinafter, a description will be given of the details of this case.

### Communication Sequence

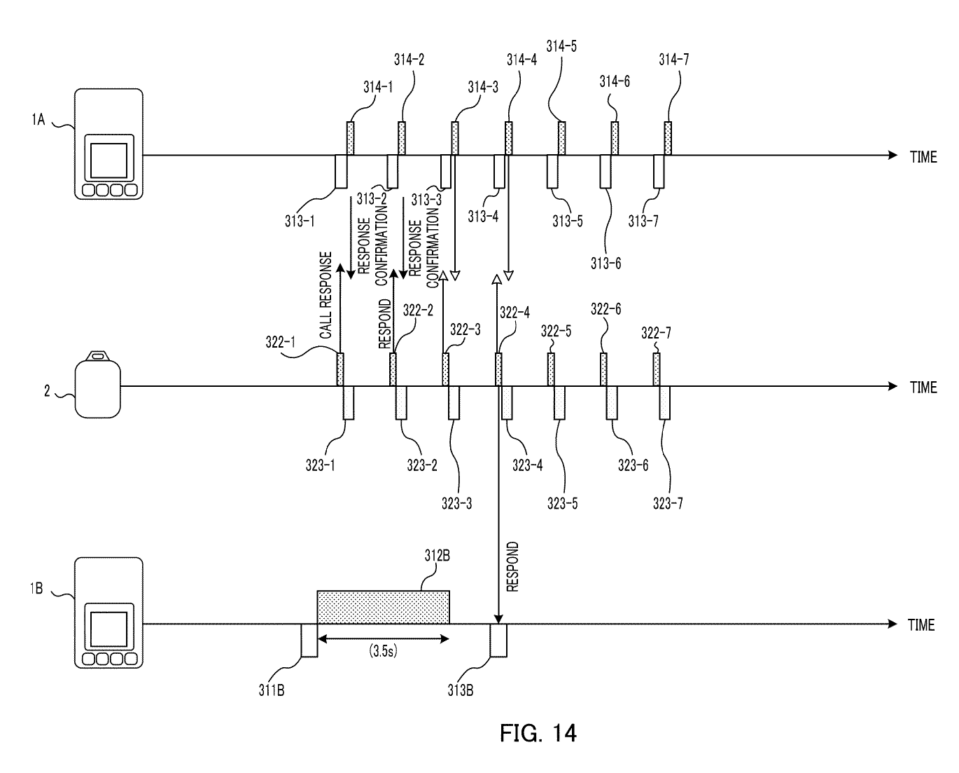

FIG. 14 is a sequence diagram illustrating how the search apparatus and search-target apparatus according to Embodiment 2 communicate with each other. In FIG. 14, search apparatus 1A carried by searcher #1A and search-target apparatus 2 carried by search-target #2 have already been in communication with each other. An assumption is made that search apparatus 1B carried by searcher #1B has started a search.

In third period 312B, search apparatus 1B repeatedly transmits a call signal containing identification information of search apparatus 1B, identification information of a search-target apparatus, which is the search-target, and timing information indicating transmission timing of a response signal with respect to this search-target apparatus 2 as has been described in Embodiment 1 (FIG. 5).

Subsequently, search apparatus 1B receives a response signal transmitted from search-target apparatus 2 to search apparatus 1A in fifth period 313B. This response signal contains the identification information of search-target apparatus 2 and the identification information of search apparatus 1A in communication, for example, so that search apparatus 1B can recognize that search-target apparatus 2 is in communication with search apparatus 1A. Upon reception of the response signal containing the identification information of another search apparatus, search apparatus 1B performs, by control of signal acquisition section 131b, display processing for predetermined information to be described hereinafter.

In the above description, the case has been described where search apparatus 1B shifts to a display operation based on the information contained in the response signal transmitted from search-target apparatus 2. However, in Embodiment 2, there may be a case where search apparatus 1B shifts to a display operation based on the information contained in the response confirmation signal transmitted from search apparatus 1A.

Whether search apparatus 1B receives the response signal from search-target apparatus 2 or the response confirmation signal transmitted from search apparatus 1A in fifth period 313B, depends on the position relationship between search apparatus 1B and search-target apparatus 2 or search apparatus 1A. Although it depends on the landform, in general, when the distance between search apparatus 1B and search apparatus 1A is shorter than the distance between search apparatus 1B and search-target apparatus 2, it is more likely that search apparatus 1B receives a response confirmation signal from search apparatus 1A in fifth period 313B.

### Description of Flow

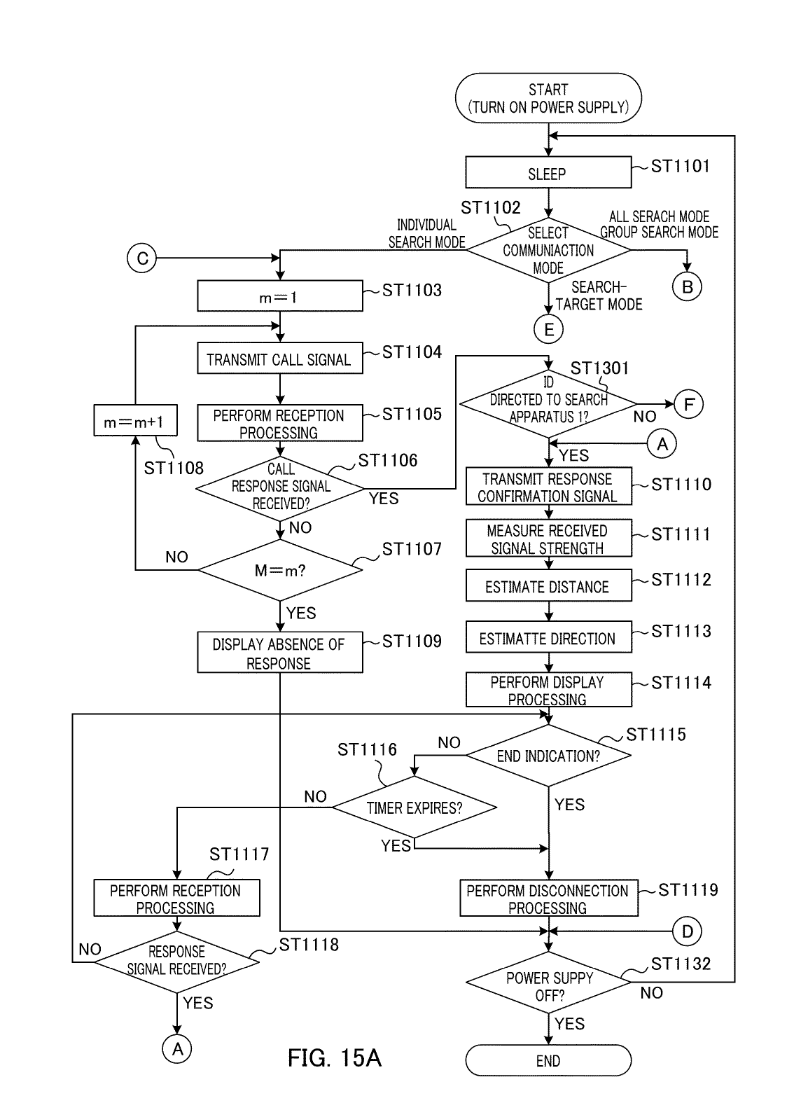

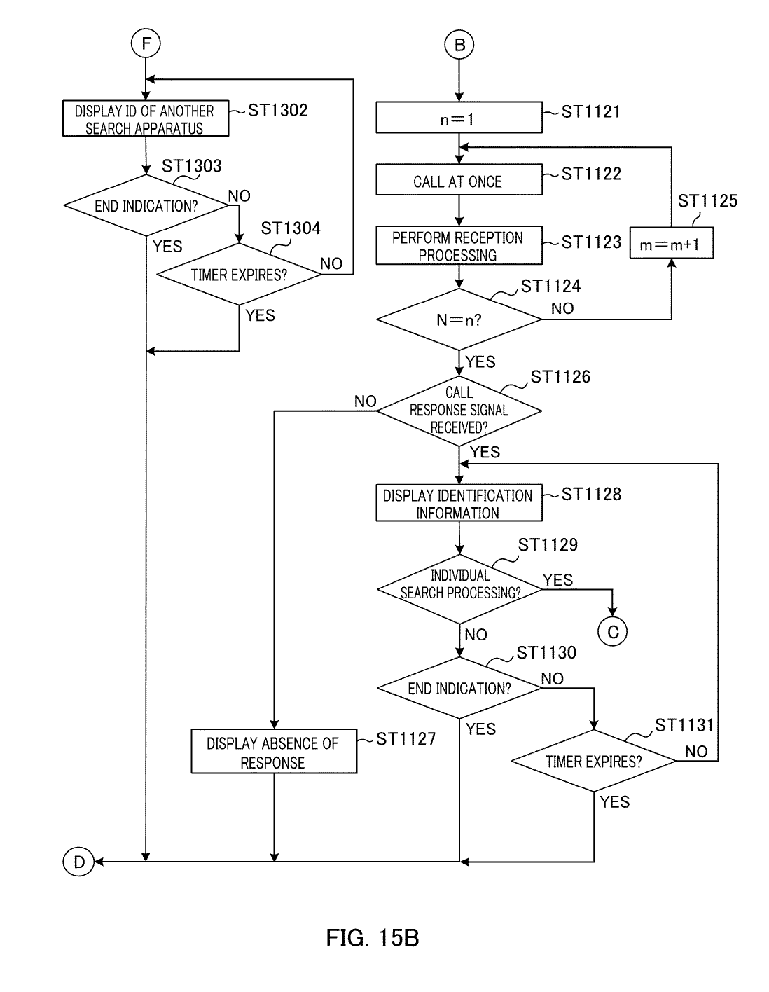

FIGS. 15A and 15B illustrate a flowchart indicating the operation flow of the search apparatus according to Embodiment 2. Note that, in FIGS. 15A and 15B, the steps common to FIGS. 11A and 11B are assigned the same reference numerals and the description of the steps will be omitted. In FIGS. 15A and 15B, STS 1301 to 1304 are added as compared with FIGS. 11A and 11B.

In a case where a call response signal is successfully received in ST 1105 (ST 1106: YES), search apparatus 1 determines the identification information contained in the call response signal or call signal (ST 1301).

In a case where the identification information is one that is directed to search apparatus 1 (ST 1301: YES), the flow moves to ST 1110, and search apparatus 1 right away transmits a response confirmation signal to search-target apparatus 2 (ST 1110).

Meanwhile, in a case where the identification information is one that is directed to another search apparatus (ST 1301: NO), search apparatus 1 causes, by control of signal acquisition section 131b, the identification information of the other search apparatus to be displayed on display section 12 (ST 1302).

Subsequently, when no search end indication is given from the user (ST 1303: NO), and the timer that counts a predetermined time has not expired (ST 1304: NO), search apparatus 1 repeats the step of ST 1302. Meanwhile, when a search end indication is given from the user (ST 1303: YES), or the timer that counts a predetermined time has expired (ST 1304: YES), the flow proceeds to ST 1132.

### Display Screen

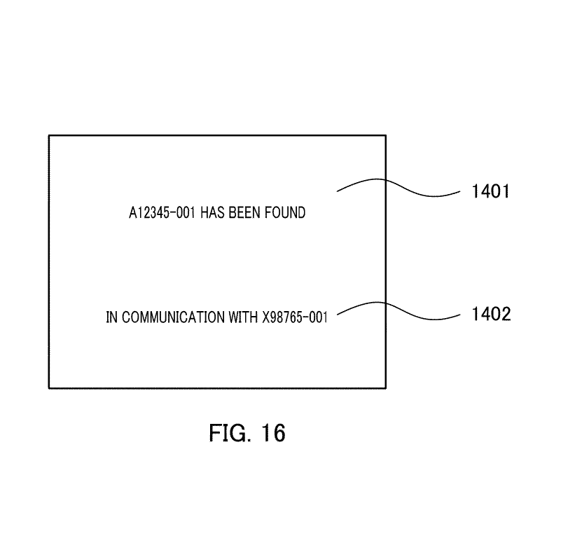

FIG. 16 illustrates a screen of search apparatus 1 in ST 1302. This screen is displayed after the screen illustrated in FIG. 10A, in a case where search-target apparatus 2 is in communication with another search apparatus 1. On this screen, identification information 1401 of search-target apparatus 2 and identification information 1402 of another search apparatus 1 in communication with this search-target apparatus 2 are displayed.

### Effects

As has been described above, according to Embodiment 2, a search apparatus can cause the identification information of another search apparatus in communication with a search-target apparatus to be displayed. Thus, each member can easily and promptly find out, without using another communication means, that one member of the team has successfully communicated with the search-target apparatus of the search-target. Accordingly, the all members of the team can promptly and efficiently perform rescue activities for a lost climber or the like in cooperation with each other.

In addition, a search apparatus can acquire, from a response confirmation signal from another search apparatus in communication with a search-target apparatus, the identification information of the other search apparatus. Thus, there is a possibility for each member to find out, even when the member is out of the coverage area of a signal from the search-target apparatus, that one member of the team has successfully communicated with the search-target apparatus of the search-target. Thus, according to this embodiment, it is possible to increase the search area.

In this embodiment, although the case has been described where, on the screen of search apparatus 1, the identification information of search-target apparatus 2 and the identification information of another search apparatus are displayed, the present invention is not limited to this case. For example, search apparatus 1 may include a speaker and cause the identification information of search-target apparatus 2 and the identification information of another search apparatus to be output from the speaker as audio.

This application is based upon and claims the benefit of priority from Japanese Patent Applications No. 2013-245284, filed on Nov. 27, 2013, and No. 2014-094510, filed on May 1, 2014, the contents of which including the specifications and drawings are incorporated herein by reference in their entirety.

### INDUSTRIAL APPLICABILITY

The present invention is suitable for use in a search apparatus for searching a position of another communication apparatus and also in a communication system composed of a search apparatus and a search-target apparatus.

### REFERENCE SIGNS LIST

1 Search apparatus
2 Search-target apparatus
11, 21 Case
12 Display section
13 Operation section
14, 23 Power supply switch
15 Substrate
16 Recess portion
22 LED
101, 201 Antenna
102, 202 Radio section
103, 203 Control section
104, 204 Sound section
105, 205 Battery (Power supply section)
111 First antenna element
112 Second antenna element
113 Third antenna element
121, 221 Transmission section
122, 222 Reception section
123, 223 Radio control section
124, 224 First clock
125, 225 First switch
126 Second switch
127 Third switch
131, 231 CPU
131a, 231a Signal generation section
131b, 231b Signal acquisition section
131c Distance estimation section
131d Direction estimation section
132, 232 Memory section
133, 233 Second clock
134, 234 Third clock
135 Logical operation section

1. A search apparatus that is portable and that performs radio communication with a portable search-target apparatus, the search apparatus comprising:
a transmission section that transmits a call signal to the search-target apparatus;
a reception section that receives a response signal from the search-target apparatus; and
a control section that acquires, from the response signal, when the search-target apparatus is in communication with another search apparatus, identification information of the other search apparatus in communication with the search-target apparatus, and that causes the acquired identification information to be output.

2. A search apparatus that is portable and that performs radio communication with a portable search-target apparatus, the search apparatus comprising:
a transmission section that transmits a call signal to the search-target apparatus;
a reception section that receives a response signal from the search-target apparatus or a response confirmation signal transmitted from another search apparatus in communication with the search-target apparatus, the response confirmation signal corresponding to the response signal; and
a control section that acquires identification information of the search-target apparatus and identification information of the other search apparatus from the response signal or the response confirmation signal, and that causes the acquired identification information to be output.
